(19) United States
(12) Patent Application Publication
(10) Pub. No.: US 2019/0371021 A1
(43) Pub. Date: Dec. 5, 2019

(54) Method and System for Co-Locating Disparate Media Types into a Cohesive Virtual Reality Experience

(71) Applicant: Microsoft Technology Licensing, LLC, Redmond, WA (US)

(72) Inventors: Felix Gerard Torquil Ifor ANDREW, Seattle, WA (US); Jeff WEST, Seattle, WA (US); Andi Fabian RUSU, Seattle, WA (US); Silvana P. MONCAYO, Seattle, WA (US)

(73) Assignee: Microsoft Technology Licensing, LLC, Redmond, WA (US)

(21) Appl. No.: 15/996,647

(22) Filed: Jun. 4, 2018

(51) Int. Cl. G06T 11/60; G06N 99/00

(52) U.S. Cl. CPC G06T 11/60; G06K 9/00288; G06N 99/005

(57) ABSTRACT

Described herein is a system and method for co-locating disparate media types into a virtual reality experience. Input is received from a user including temporal information, geographical information, and/or entity information for building the virtual reality experience. Media items are identified in accordance with the received user input, at least some of the media items being of disparate media types. In some embodiments, the media items are identified using a cloud-based operating system component that stores information regarding utilization of device(s) by the user. The virtual reality experience is built by selecting at least some of the identified media items to be included in the virtual reality experience and organizing the selected media items. In some embodiments, the media items to be included are selected using a selection model trained using a machine learning algorithm. The virtual reality experience is provided in accordance with the arranged, selected media items.

### BACKGROUND

Virtual reality systems allow users to experience content with full sensory immersion in a virtual environment. For example, a user can experience virtual reality via a traditional display of a computer system. However, a virtual reality device such as a head-mounted display can provide the user with a three-dimensional experience.

### SUMMARY

Described herein is a system for co-locating disparate media types into a virtual reality experience, comprising: a computer comprising a processor and a memory having computer-executable instructions stored thereupon which, when executed by the processor, cause the computer to: receive input from a user comprising at least one of temporal information, geographical information or entity information for building the virtual reality experience; identify a plurality of media items in accordance with the received user input, at least some of the media items being of disparate media types; build the virtual reality experience by selecting at least some of the identified media items to be included in the virtual reality experience and organizing the selected media items; and provide the virtual reality experience in accordance with the arranged, selected media items.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for co-locating disparate media types into a virtual reality experience.

FIG. 2 is a flow chart that illustrates a method of co-locating disparate media types into a virtual reality experience.

FIG. 3 is a flow chart that illustrates another method of co-locating disparate media types into a virtual reality experience.

FIG. 4 is a functional block diagram that illustrates an exemplary computing system.

### DETAILED DESCRIPTION

Various technologies pertaining to co-locating disparate media types into a virtual reality experience are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding co-locating disparate media types into a virtual reality experience. What follows are one or more exemplary systems and methods.

Aspects of the subject disclosure pertain to the technical problem of building a cohesive virtual reality experience. The technical features associated with addressing this problem involve receiving input from a user comprising temporal information, geographical information, and/or entity information for building a virtual reality experience; identifying media items in accordance with the received user input, at least some of the media items being of disparate media types; building the virtual reality experience by selecting at least some of the identified media items to be included in the virtual reality experience and organizing the selected media items; and providing the virtual reality experience in accordance with the arranged, selected media items. Accordingly, aspects of these technical features exhibit technical effects of more efficiently and effectively building a cohesive virtual reality experience thus reducing computer resource(s) and/or increasing user satisfaction.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

With increasing frequency computing devices have become intertwined with user's everyday lives. Most experiences a user has are based on generation and/or consumption of data, for example, website(s) utilized, communication(s) the user has participated in, playlists the user has created, music the user has listened to, physical location(s) the user has visited (or desires to visit), information regarding people who visited the location(s) with the user. Frequently, this data is managed by different applications.

Described herein is a system and method for co-locating disparate media types into a cohesive virtual reality experience. Based upon received temporal information (e.g., date and/or time), geographical information (e.g., city, latitude and longitude), and/or entity information, related media items of disparate media types can be identified. “Media type” refers to content format for computer data (e.g., referred to, consumed, and/or generated by a computer application). By way of example and not limitation, “media type” includes application, audio, image, multipart, message, text, and/or video. The virtual reality experience can be built by selecting at least some of the identified media items and organizing the selected media items into a cohesive virtual reality experience. In some embodiments, the virtual reality experience can be constructed that comprises a virtual room to house digital assets which allows for a simplified way for a user to re-live the experience and expose the interconnectedness of times, places and/or people into one virtual reality experience.

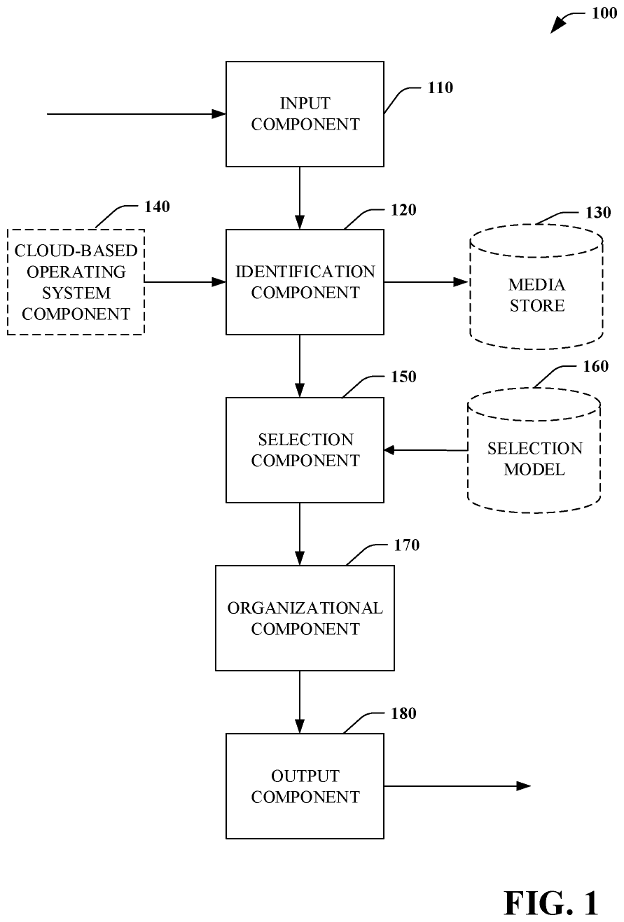

Referring to FIG. 1, a system for co-locating disparate media types into a virtual reality experience 100 is illustrated. The system 100 can build a virtual reality experience based upon temporal information, geographical information, and/or entity information received from a user.

In some embodiments, the system 100 can build a virtual reality experience based upon temporal information. For example, a user can request a virtual reality experience to be built for a particular date or range of dates (e.g., vacation). Based upon the date or range of dates, the system 100 can identify relevant media items, select which of those media items to include and arrange the selected media items into the requested virtual reality experience.

In some embodiments, the system 100 can build a virtual reality experience based upon geographical information. For example, a user can request a virtual reality experience to be built for a physical location (e.g., “Paris”). Based upon the geographical information, the system 100 can identify relevant media items, select which of those media items to include and arrange the selected media items into the requested virtual reality experience.

The system 100 includes an input component 110 that receives input from a user to build a virtual reality experience. The input can include temporal information, geographical information and/or entity information to be used in building the virtual reality experience. In some embodiments, the temporal information can include an absolute date (May 20, 2018) or absolute range of dates (May 2018). In some embodiments, the temporal information can include a relative date or range of dates (e.g., yesterday, last month). In some embodiments, the entity information can include information identifying one or more people to include in and/or exclude from the virtual reality experience.

In some embodiments, the geographical information can include a geographical identifier (e.g., Paris, France, or Europe). In some embodiments, the geographical information can include absolute information (e.g., GPS coordinates defining a point, circular region surrounding a point, a rectangle defined by GPS coordinates, location information derived from IP address). In some embodiments, the geographical information can include information derived from temporal information (e.g., my trip in May 2018).

The system 100 further includes an identification component 120 that identifies media items in accordance with the received user input (e.g., temporal information, geographical information, and/or entity information). The media items can be of disparate media types. In some embodiments, the media items are stored in one or more media stores 130 (e.g., computer hard drive, cloud-based storage).

In some embodiments, the identification component 120 can utilize information regarding the user's utilization of a plurality of devices (and associated application(s) utilized) gathered by a cloud-based operating system component 140. In some embodiments, with consent of the user (e.g., opt-in), the cloud-based operating system component 140 can store information regarding the user's utilization (e.g., date/time, location, application(s) utilized, data generated, data consumed) of a plurality of devices (e.g., desktop computer, laptop computer, tablet, mobile phone, camera, video recorder, electronic watch, electronic fitness tracking device) across various operating systems and manufacturers. Thus, in some embodiments, the identification component 120 can query the cloud-based operating system component 140 (e.g., using application programming interface(s) (APIs)) to identify media items of disparate media types across a plurality of devices associated with the user in accordance with the received user input (e.g., temporal and/or geographical information). For example, media items related to action(s) and/or activity(ies) performed during a particular time period and/or at a particular location can be identified by the identification component 120.

In some embodiments, media items can include information stored passively. In some embodiments, applications store geo-tagged data such as date, time and/or geographical coordinates (e.g., latitude and longitude) applicable to a generated media item. This information can be stored metadata associated with the media item which can be utilized by the identification component 120 to identify media items in accordance with the received user input.

In some embodiments, identification of media items can be based upon information stored actively by a user. In some embodiments, the user may associated one or more alphanumeric tags with a media item. In some embodiments, the user may include the media item in a social media post with content associated with the media item. The content can be utilized by the identification component 120 in identifying media items. For example, a user can post “our anniversary trip to Paris” along with a photo. By mining this content (e.g., post), the identification component 140 can identify the photo as related to “Paris” and an “anniversary trip”.

The system 100 further includes a selection component 150 that selects (e.g., filters) the identified media items to be included in the virtual reality experience. In some embodiments, for each identified media item, the selection component 150 calculates probabilities that a user and/or the particular user desires to have a particular media item included in the virtual reality experience.

In some embodiments, the selection component 150 selects a predetermined quantity of the identified media items having the highest calculated probabilities (e.g., top ten). In some embodiments, the predetermined quantity can be user-configurable. In some embodiments, the predetermined quantity can be dynamically altered, for example, based upon user feedback.

In some embodiments, the selection component 150 selects identified media items having a calculated probability greater than a predetermined threshold (e.g., greater than 95%). In some embodiments, the predetermined threshold can be user-configurable. In some embodiments, the predetermined threshold can be dynamically altered, for example, based upon user feedback.

In some embodiments, the selection component 150 uses a selection model 160 to select media items to be included in the virtual reality experience. In some embodiments, the selection model 160 can be trained using a machine learning process that utilizes various features present in the user experience (e.g., applications utilized by the user, data consumed by applications utilized by the user, data generated by applications utilized by the user, social media posts of the user, social media posts associated with the user, websites visited by the user, Internet searches performed by the user) with the selection model 160 representing an association among the features. In some embodiments, the selection model 160 is trained using one or more machine learning algorithms including linear regression algorithms, logistic regression algorithms, decision tree algorithms, support vector machine (SVM) algorithms, Naive Bayes algorithms, a K-nearest neighbors (KNN) algorithm, a K-means algorithm, a random forest algorithm, dimensionality reduction algorithms, Artificial Neural Network (ANN), and/or a Gradient Boost & Adaboost algorithm. The selection model 160 can be trained in a supervised, semi-supervised and/or unsupervised manner.

In some embodiments, the selection model 160 can be a classifier trained to select media items to be included in a virtual reality experience. In some embodiments, the selection model 160 can be trained using a clustering algorithm (e.g., unsupervised learning). Once trained, the selection model 160 can be utilized by the system 100 to select media items to be included in a virtual reality experience.

In some embodiments, the selection model 160 can be trained to include and/or mine social media post(s) and/or activity(ies) when selecting media items to include in the virtual reality experience. In some embodiments, content of a social media post associated with a media item (e.g., photo) can be utilized to increase or decrease the likelihood that the particular media item should be included in the virtual reality experience. For example, positive content (e.g., “my favorite photo of our trip to Paris”) can increase likelihood of inclusion. Negative content (e.g., my worst meal ever) can decrease likelihood of inclusion.

In some embodiments, information related to other user(s) reaction(s) to the user's social media post(s) can be utilized by the selection model 160. In some embodiments, positive reactions (e.g., likes, favorable emoticons) can increase likelihood of inclusion, while negative reactions (e.g., unfavorable emoticons) can decrease likelihood of inclusion. In some embodiments, a quantity of other user(s) reaction(s) can be utilized by the selection model 160 (e.g., 500 likes of post of a photo).

In some embodiments, the selection model 160 can be trained to utilize facial recognition and/or image recognition when selecting media items to include in the virtual reality experience. In some embodiments, facial recognition can be utilized to determine one or more people that accompanied the user on a particular excursion. In some embodiments, image recognition can be utilized to determine image(s) associated with a particular geographical location. In some embodiments, the selection model 160 can be updated in accordance with user feedback regarding selection of media items to include in the virtual reality experience.

The system 100 further includes an organization component 160 that organizes the selected media items. In some embodiments, the organization component 160 utilizes a predetermined schema for placement of digital assets. In some embodiments, one or more graphical representations (e.g., photos, videos) can be placed on a wall in a three-dimensional room of the virtual reality experience. In some embodiments, one or more audio representations (e.g., recorded voice, music, playlists) can be generated when a user enters the room of the virtual reality experience. In some embodiments, geographical representation(s) (e.g., maps, pamphlets, photos) related to place(s) discussed, visited and/or desired to be visited can be placed on a virtual table or other object within the room of the virtual reality experience.

The system 100 includes an output component 170 that provides the virtual reality experience in accordance with the organized, selected media items. In some embodiments, the output component 170 provides the virtual reality experience to a user equipped with a virtual reality headset. In some embodiments, the output component 170 provides the virtual reality experience to the user for display on a computer system. In some embodiments, the output component 170 provides the virtual reality experience for storage (e.g., to be experienced at a later time).

By identifying and selecting media items of disparate media types, the system 100 can create a cohesive virtual reality experience custom-tailored to the user allowing the user a virtual space to review co-located media items of disparate media types in order to re-live or re-experience all or selected portions of a particular experience. For example, the user can selectively review photos, videos, audio recordings, social media posts, websites visited, telecommunications application(s) utilized, playlist lists, music, physical locations visited, and/or physical locations searched for relative to the requested temporal, geographical information, and/or entity information.

In some embodiments, the system 100 allows for the user to share the virtual reality experience with other user(s). The user and the other user(s) can thus use the virtual reality experience built by the system 100 as a virtual meeting place (e.g., collaboration space), for example, to discuss all or selected portions of the experience.

In some embodiments, the other user(s) can consent to sharing their own virtual reality experiences with the user. In some embodiments, these virtual reality experiences can be jointly explored by the user and/or the other user(s), for example, as adjacent rooms in a virtual structure.

As noted above, many experiences a user has are based on generation and consumption of data, for example, the photos they take, the websites they use, the telecommunication calls they make, the play lists they create, the music they listen to, the locations they visit (or wished to visit), and/or the people they went with. In some embodiments, this data can be managed by different applications, making re-constructing the experience with the media items and/or assets extremely time-consuming and impractical. In some embodiments, the system 100 constructs a virtual room to house selected assets and simplify the re-live experience exposing the interconnectedness of times, places and/or people into a cohesive virtual reality experience.

In some embodiments, the system 100 can automatically group video(s), photo(s), music, one or more people, and/or location(s) over time into a virtual reality room. For example, the room can have a unique play list (e.g., based on the play lists created at a particular geographical location). In some embodiments, the room can include photos from a particular trip on an easily accessible ‘table’ in the center of the room. In some embodiments, the walls in the room can be decorated with the highly rated (e.g., 5 star) photos from the particular trip. In some embodiments, the walls in the room can further be decorated with photo(s) of tourist attractions, restaurants, museums visited. In some embodiments, interacting with these virtual assets can “teleport” the user to those places in virtual reality and/or play a 360 degree video. In some embodiments, around the virtual table would be virtual representations of people from the trip, interacting with the virtual representation can initiate a telecommunications session with the person(s) with them. In some embodiments, the person(s) can then join the user in the virtual reality experience.

In some embodiments, the system 100 can determine connection(s) between adjacent room(s) of the house automatically based, for example, upon temporal information, geographical information and/or logical information (e.g., grouping of one or more people). In some embodiments, for a trip beginning in Paris and continuing to Rome, the system 100 can build a virtual reality experience comprising a room for the Paris portion of the vacation with an adjacent room for the Rome portion of the vacation. In some embodiments, for two or more visits to a same geographical location, the system 100 can build a virtual reality experience, for example, comprising adjacent rooms for each time period visiting the location.

In some embodiments, adjacent room(s) can be built based upon grouping(s) of people and/or activity(ies). For example, if a subgroup of people participated in a bike ride, an adjacent room can be built for that the activity and subgroup of people.

In some embodiments, room(s) can be built based on temporal information (e.g., past, present and/or future). For example, adjacent rooms can be built regarding a user's past trip to Paris, current trip to Paris, and planned future trip(s) to Paris.

In some embodiments, music in the virtual room is at an ambient level when a user is in the virtual room. In some embodiments, when the user is walking past the room, the user can hear the music “leaking out” of each particular room, thus drawing the user into the particular room to re-experience/re-live the time spent there (e.g., birthday in Madrid, wedding in Florence).

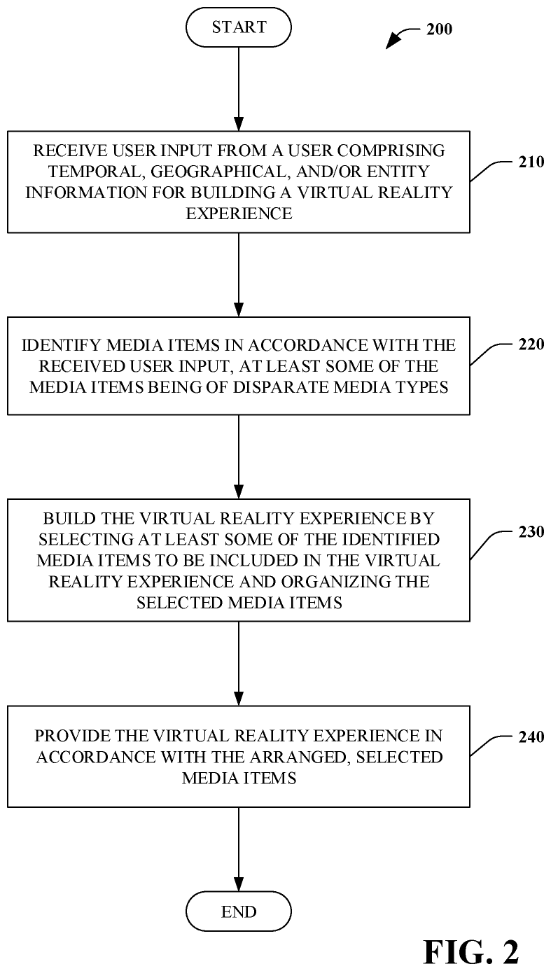

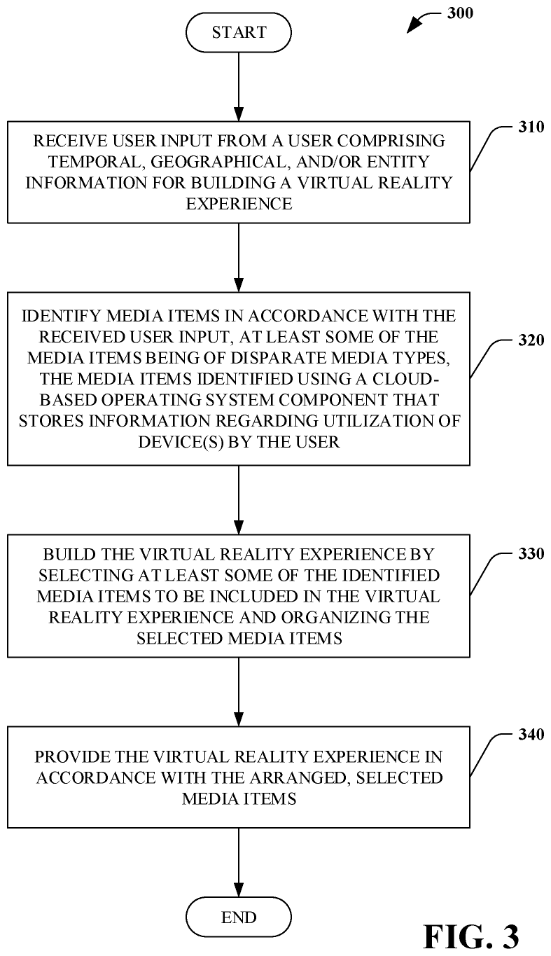

FIGS. 2 and 3 illustrate exemplary methodologies relating to co-locating disparate media types into a virtual reality experience. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 2, a method of co-locating disparate media types into a virtual reality experience 200 is illustrated. In some embodiments, the method 200 is performed by the system 100.

At 210, input comprising at least one of temporal information, geographical information, and/or entity information for building a virtual reality experience is received from a user. At 220, a plurality of media items is identified in accordance with the received user input. At least some of the media items are of disparate media types.

At 230, the virtual reality experience is built by selecting at least some of the identified media items to be included in the virtual reality experience and organizing the selected media items. At 240, the virtual reality experience is provided in accordance with the arranged, selected media items.

Turning to FIG. 3, a method of co-locating disparate media types into a virtual reality experience 300 is illustrated. In some embodiments, the method 300 is performed by the system 100.

At 310, input user comprising at least one of temporal information, geographical information, and/or entity information for building a virtual reality experience is received from a user. At 320, a plurality of media items is identified in accordance with the received user input. At least some of the media items being are of disparate media types. The media items are identified using a cloud-based operating system component that stores information regarding utilization of device(s) by the user.

At 330, the virtual reality experience is built by selecting at least some of the identified media items to be included in the particular virtual reality experience using a selection model trained using a machine learning algorithm. The selected media items are then organized. At 340, the virtual reality experience is provided in accordance with the organized, selected media items.

Described herein is a system for co-locating disparate media types into a virtual reality experience, comprising: a computer comprising a processor and a memory having computer-executable instructions stored thereupon which, when executed by the processor, cause the computer to: receive input from a user comprising at least one of temporal information, geographical information or entity information for building the virtual reality experience; identify a plurality of media items in accordance with the received user input, at least some of the media items being of disparate media types; build the virtual reality experience by selecting at least some of the identified media items to be included in the virtual reality experience and organizing the selected media items; and provide the virtual reality experience in accordance with the arranged, selected media items.

The system can further include wherein the virtual reality experience is modifiable by the user. The system can further include wherein selection of the media items to be included is performed using a selection model trained using a machine learning process utilizing features present in the user experience with the selection model representing an association among the features. The system can further include wherein the user experience comprises at least one of applications utilized by the user, data consumed by applications utilized by the user, data generated by applications utilized by the user, social media posts of the user, social media posts associated with the user, websites visited by the user, Internet searches performed by the user.

The system can further include wherein the selection model is trained using one or more machine learning algorithms including a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an Artificial Neural Network (ANN), or a Gradient Boost & Adaboost algorithm. The system can further include wherein the selection model utilizes at least one of facial recognition or image recognition when selecting media items to include in the virtual reality experience.

The system can further include wherein organization of the selected media items is performed utilizing a predetermined schema for placement of digital assets. The system can further include the memory having further computer-executable instructions stored thereupon which, when executed by the processor, cause the computer to: receive input from the user to share the virtual reality experience with another user; and share the virtual reality experience with the another user.

The system can further include wherein the plurality of media items is identified using a cloud-based operating system component that stores information regarding utilization of one or more devices by the user. The system can further include wherein at least some of the plurality of media items are identified based upon geo-tagged data associated with a particular media item. The system can further include wherein at least some of the plurality of media items are identified based upon information associated with a particular media item provided by the user.

Described herein is a method of co-locating disparate media types into a virtual reality experience, comprising: receiving input from a user comprising at least one of temporal information, geographical information or entity information for building the virtual reality experience; identifying a plurality of media items in accordance with the received user input, at least some of the media items being of disparate media types; building the virtual reality experience by selecting at least some of the identified media items to be included in the virtual reality experience and organizing the selected media items; and providing the virtual reality experience in accordance with the arranged, selected media items.

The method can further include wherein selection of the media items to be included is performed using a selection model trained using a machine learning process utilizing features present in the user experience with the selection model representing an association among the features. The method can further include wherein the selection model utilizes at least one of facial recognition or image recognition when selecting media items to include in the virtual reality experience. The method can further include wherein the plurality of media items is identified using a cloud-based operating system component that stores information regarding utilization of one or more devices by the user.

The method can further include wherein at least some of the plurality of media items are identified based upon geo-tagged data associated with a particular media item. The method can further include wherein at least some of the plurality of media items are identified based upon information associated with a particular media item provided by the user.

Described herein is a computer storage media storing computer-readable instructions that when executed cause a computing device to: receive input from a user comprising at least one of temporal information, geographical information or entity information for building a virtual reality experience; identify a plurality of media items associated in accordance with the received user input, at least some of the media items being of disparate media types, the media items identified using a cloud-based operating system component that stores information regarding utilization of a plurality of devices by the user; build the virtual reality experience by selecting at least some of the identified media items to be included in the particular virtual reality experience using a selection model trained using a machine learning algorithm, and organizing the selected media items; and provide the virtual reality experience in accordance with the organized, selected media items.

The computer storage media can further include wherein the machine learning process utilizes features present in the user experience with the selection model representing an association among the features, and the user experience comprises at least one of applications utilized by the user, data consumed by applications utilized by the user, data generated by applications utilized by the user, social media posts of the user, social media posts associated with the user, websites visited by the user, Internet searches performed by the user. The computer storage media can further include wherein at least some of the plurality of media items are identified based upon geo-tagged data associated with a particular media item.

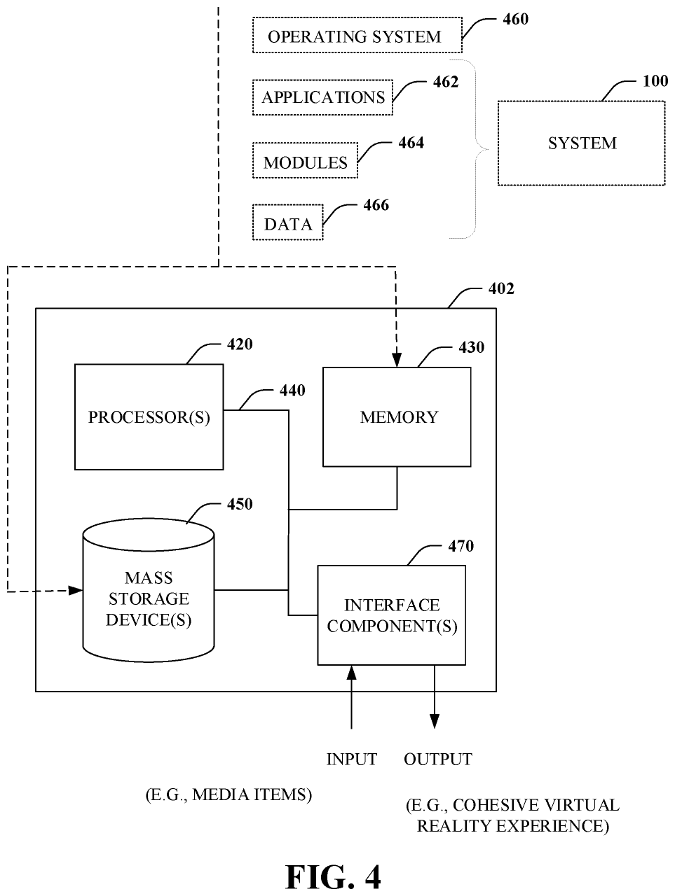

With reference to FIG. 4, illustrated is an example general-purpose computer or computing device 402 (e.g., mobile phone, desktop, laptop, tablet, watch, server, hand-held, programmable consumer or industrial electronics, set-top box, game system, compute node, etc.). For instance, the computing device 402 may be used in a system for co-locating disparate media types into a virtual reality experience 100.

The computer 402 includes one or more processor(s) 420, memory 430, system bus 440, mass storage device(s) 450, and one or more interface components 470. The system bus 440 communicatively couples at least the above system constituents. However, it is to be appreciated that in its simplest form the computer 402 can include one or more processors 420 coupled to memory 430 that execute various computer executable actions, instructions, and or components stored in memory 430. The instructions may be, for instance, instructions for implementing functionality described as being carried out by one or more components discussed above or instructions for implementing one or more of the methods described above.

The processor(s) 420 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 420 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 420 can be a graphics processor.

The computer 402 can include or otherwise interact with a variety of computer-readable media to facilitate control of the computer 402 to implement one or more aspects of the claimed subject matter. The computer-readable media can be any available media that can be accessed by the computer 402 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 402. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 430 and mass storage device(s) 450 are examples of computer-readable storage media. Depending on the exact configuration and type of computing device, memory 430 may be volatile (e.g., RAM), non-volatile (e.g., ROM, flash memory, etc.) or some combination of the two. By way of example, the basic input/output system (BIOS), including basic routines to transfer information between elements within the computer 402, such as during start-up, can be stored in nonvolatile memory, while volatile memory can act as external cache memory to facilitate processing by the processor(s) 420, among other things.

Mass storage device(s) 450 includes removable/non-removable, volatile/non-volatile computer storage media for storage of large amounts of data relative to the memory 430. For example, mass storage device(s) 450 includes, but is not limited to, one or more devices such as a magnetic or optical disk drive, floppy disk drive, flash memory, solid-state drive, or memory stick.

Memory 430 and mass storage device(s) 450 can include, or have stored therein, operating system 460, one or more applications 462, one or more program modules 464, and data 466. The operating system 460 acts to control and allocate resources of the computer 402. Applications 462 include one or both of system and application software and can exploit management of resources by the operating system 460 through program modules 464 and data 466 stored in memory 430 and/or mass storage device (s) 450 to perform one or more actions. Accordingly, applications 462 can turn a general-purpose computer 402 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 462, and include one or more modules 464 and data 466 stored in memory and/or mass storage device(s) 450 whose functionality can be realized when executed by one or more processor(s) 420.

In accordance with one particular embodiment, the processor(s) 420 can correspond to a system on a chip (SOC) or like architecture including, or in other words integrating, both hardware and software on a single integrated circuit substrate. Here, the processor(s) 420 can include one or more processors as well as memory at least similar to processor(s) 420 and memory 430, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 402 also includes one or more interface components 470 that are communicatively coupled to the system bus 440 and facilitate interaction with the computer 402. By way of example, the interface component 470 can be a port (e.g., serial, parallel, PCMCIA, USB, FireWire, etc.) or an interface card (e.g., sound, video, etc.) or the like. In one example implementation, the interface component 470 can be embodied as a user input/output interface to enable a user to enter commands and information into the computer 402, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 470 can be embodied as an output peripheral interface to supply output to displays (e.g., LCD, LED, plasma, etc.), speakers, printers, and/or other computers, among other things. Still further yet, the interface component 470 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for co-locating disparate media types into a virtual reality experience, comprising:
a computer comprising a processor and a memory having computer-executable instructions stored thereupon which, when executed by the processor, cause the computer to:
receive input from a user comprising at least one of temporal information, geographical information or entity information for building the virtual reality experience;
identify a plurality of media items in accordance with the received user input, at least some of the media items being of disparate media types;
build the virtual reality experience by selecting at least some of the identified media items to be included in the virtual reality experience and organizing the selected media items; and
provide the virtual reality experience in accordance with the arranged, selected media items.

2. The system of claim 1, wherein the virtual reality experience is modifiable by the user.

3. The system of claim 1, wherein selection of the media items to be included is performed using a selection model trained using a machine learning process utilizing features present in the user experience with the selection model representing an association among the features.

4. The system of claim 3, wherein the user experience comprises at least one of applications utilized by the user, data consumed by applications utilized by the user, data generated by applications utilized by the user, social media posts of the user, social media posts associated with the user, websites visited by the user, Internet searches performed by the user.

5. The system of claim 3, wherein the selection model is trained using one or more machine learning algorithms including a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an Artificial Neural Network (ANN), or a Gradient Boost & Adaboost algorithm.

6. The system of claim 3, wherein the selection model utilizes at least one of facial recognition or image recognition when selecting media items to include in the virtual reality experience.

7. The system of claim 1, wherein organization of the selected media items is performed utilizing a predetermined schema for placement of digital assets.

8. The system of claim 1, the memory having further computer-executable instructions stored thereupon which, when executed by the processor, cause the computer to:
receive input from the user to share the virtual reality experience with another user; and
share the virtual reality experience with the another user.

9. The system of claim 1, wherein the plurality of media items is identified using a cloud-based operating system component that stores information regarding utilization of one or more devices by the user.

10. The system of claim 1, wherein at least some of the plurality of media items are identified based upon geo-tagged data associated with a particular media item.

11. The system of claim 1, wherein at least some of the plurality of media items are identified based upon information associated with a particular media item provided by the user.

12. A method of co-locating disparate media types into a virtual reality experience, comprising:
receiving input from a user comprising at least one of temporal information, geographical information or entity information for building the virtual reality experience;
identifying a plurality of media items in accordance with the received user input, at least some of the media items being of disparate media types;
building the virtual reality experience by selecting at least some of the identified media items to be included in the virtual reality experience and organizing the selected media items; and
providing the virtual reality experience in accordance with the arranged, selected media items.

13. The method of claim 12, wherein selection of the media items to be included is performed using a selection model trained using a machine learning process utilizing features present in the user experience with the selection model representing an association among the features.

14. The method of claim 13, wherein the selection model utilizes at least one of facial recognition or image recognition when selecting media items to include in the virtual reality experience.

15. The method of claim 12, wherein the plurality of media items is identified using a cloud-based operating system component that stores information regarding utilization of one or more devices by the user.

16. The method of claim 12, wherein at least some of the plurality of media items are identified based upon geo-tagged data associated with a particular media item.

17. The method of claim 12, wherein at least some of the plurality of media items are identified based upon information associated with a particular media item provided by the user.

18. A computer storage media storing computer-readable instructions that when executed cause a computing device to:
receive input from a user comprising at least one of temporal information, geographical information or entity information for building a virtual reality experience;
identify a plurality of media items associated in accordance with the received user input, at least some of the media items being of disparate media types, the media items identified using a cloud-based operating system component that stores information regarding utilization of a plurality of devices by the user;
build the virtual reality experience by selecting at least some of the identified media items to be included in the particular virtual reality experience using a selection model trained using a machine learning algorithm, and organizing the selected media items; and
provide the virtual reality experience in accordance with the organized, selected media items.

19. The computer storage media of claim 18, wherein the machine learning process utilizes features present in the user experience with the selection model representing an association among the features, and the user experience comprises at least one of applications utilized by the user, data consumed by applications utilized by the user, data generated by applications utilized by the user, social media posts of the user, social media posts associated with the user, websites visited by the user, Internet searches performed by the user.

20. The computer storage media of claim 18, wherein at least some of the plurality of media items are identified based upon geo-tagged data associated with a particular media item.
